(19) United States
(12) Patent Application Publication
(10) Pub. No.: US 2020/0113161 A1
(43) Pub. Date: Apr. 16, 2020

(54) FISHING DEVICES, SYSTEMS, AND METHODS

(71) Applicant: Steve C. Edwards, Vidor, TX (US)

(72) Inventor: Steve C. Edwards, Vidor, TX (US)

(21) Appl. No.: 16/160,113

(22) Filed: Oct. 15, 2018

(51) Int. Cl. A01K 85/02

(52) U.S. Cl. CPC A01K 85/02

(57) ABSTRACT

Disclosed are devices, systems and methods for fishing. In one aspect, disclosed is a device having a hollow tube, which has a first end and a second end, wherein the first end and the second end are open-ended and on opposite ends of the hollow tube. Further, the device may include at least one slot at the first end, wherein the first end is optionally flared. Further still, the device may include a first slot located along a longest length of the hollow tube, and a second slot located between the first end and the first slot, wherein the second slot is optionally oriented at least substantially perpendicular to the first slot.

### FIELD

This disclosure relates to fishing devices, systems and methods, and in particular, to safety and release concerns with fishing hooks.

### BACKGROUND

Over millennia, fishing hooks have injured and frustrated countless fishermen. Oftentimes, fishermen endure injuries such skin punctures or worse when attaching or detaching fishing hooks to or from lines, rolling or unrolling lines having hooks, such as trotlines, or detangling lines having hooks. Even if fishermen avert injuries, then prior solutions to this disclosure still frustrate and fatigue fishermen because of the slow pace needed for safety.

### SUMMARY

Disclosed are devices, systems and methods for fishing. In one aspect, disclosed is a device having a hollow tube, which has a first end and a second end, wherein the first end and the second end are open-ended and on opposite ends of the hollow tube. Further, the device may include at least one slot at the first end, wherein the first end is optionally flared. Further still, the device may include a first slot located along a longest length of the hollow tube, and a second slot located between the first end and the first slot, wherein the second slot is optionally oriented at least substantially perpendicular to the first slot.

In another aspect, disclosed is a system that may include a plurality of fishing devices, each of which may comprise: (1) a hollow tube having a first end and a second end, wherein the first end and the second end are open-ended and on opposite ends of the hollow tube; (2) at least one slot at the first end, wherein the first end is optionally flared; (3) a first slot located along a longest length of the hollow tube; and (4) a second slot located between the first end and the first slot, wherein the second slot is optionally oriented at least substantially perpendicular to the first slot. Further, the system may include at least one main line having a plurality of staging lines, wherein at least one of the plurality of staging lines terminates in a fishing hook, wherein the at least one main line traverses the hollow tube of each of the plurality of fishing devices.

In yet another aspect, disclosed is a fishing method that may include positioning a a fishing device on at least one main line, wherein the fishing device may include: (1) a hollow tube having a first end and a second end, wherein the first end and the second end are open-ended and on opposite ends of the hollow tube; (2) at least one slot at the first end, wherein the first end is optionally flared; (3) a first slot located along a longest length of the hollow tube; and (4) a second slot located between the first end and the first slot, wherein the second slot is optionally oriented at least substantially perpendicular to the first slot. Further, the fishing method may include storing or deploying a fishing hook in or from, at least one of the first pair of slots, wherein the fishing hook is attached, directly or indirectly, to a staging line attached, directly or indirectly, to the at least one main line.

### BRIEF DESCRIPTION OF THE DRAWINGS

So that the manner in which the above recited features, advantages and objects of this disclosure are attained and may be understood in detail, a more particular description, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for the disclosure may admit to other equally effective embodiments.

FIG. 1A shows a fishing device comprising a hollow tube having a first end and a second end, which are open-ended and on opposite sides of the hollow tube. Further depicted are the first and second ends each having at least one slot (and, in these example embodiments, having two slots on each end), a closer end, and an interior of the hollow tube.

FIG. 1B shows a top view of a hollow tube that includes at least one slot at each of the first and second ends and also shows a third slot.

FIG. 1C shows a side view of a hollow tube having straight first and second ends as well as a second slot.

FIG. 1D shows a side view of a hollow tube that includes a third slot, wherein the hollow tube has flared first and second ends.

FIG. 2A shows a fishing hook attached to a staging line, which is attached to at least one main line. A main line traverses a portion of the main line, which is removably stored in at least one slot at the first end, the second slot, or both. The fishing hook is stored in at least one slot at the first end in this example embodiment.

FIG. 2B shows a fishing hook attached to a staging line, which is attached to at least one main line. A main line traverses the hollow tube, wherein a portion of the main line is disengaged from at least one slot at the first end, the second slot, or both as compared to FIG. 2A. The fishing hook removably is still stored in at least one slot at the first end in this example embodiment.

FIG. 2C shows a fishing hook attached to a staging line, which is attached to a main line. A main line traverses the hollow tube. The fishing hook is located beneath the first slot.

FIG. 2D shows two fishing devices, and, more particularly, two hollow tubes and two fishing hooks on two staging lines, which are attached to at least one main line that traverses both hollow tubes. The fishing hooks are located beneath their respective first slots.

FIG. 3A shows a side view of the hollow tube with at least one slot at the first end, a hinge, and a fastening mechanism in a closed position.

FIG. 3B shows a side view of the hollow tube with at least one slot at the first end, a hinge, and a fastening mechanism in an open position.

FIG. 3C shows a side view of the hollow tube with at least one slot at the first end as well as male and female interlocking members in a closed position.

FIG. 3D shows a side view of the hollow tube with at least one slot at the first end as well as male and female interlocking members in an open position.

FIG. 4 shows a plurality of fishing devices having fishing hooks attached to trotlines, which are attached to at least one main line, rolled onto a spool.

### DETAILED DESCRIPTION

Various specific embodiments, versions and examples are described now, including exemplary embodiments and definitions that are adopted herein for purposes of understanding. While the following detailed description gives specific preferred embodiments, those skilled in the art will appreciate that these embodiments are exemplary only, and that the disclosure can be practiced in other ways. For purposes of determining infringement, the scope of the invention will refer to the any claims, including their equivalents, and elements or limitations that are equivalent to those that are recited.

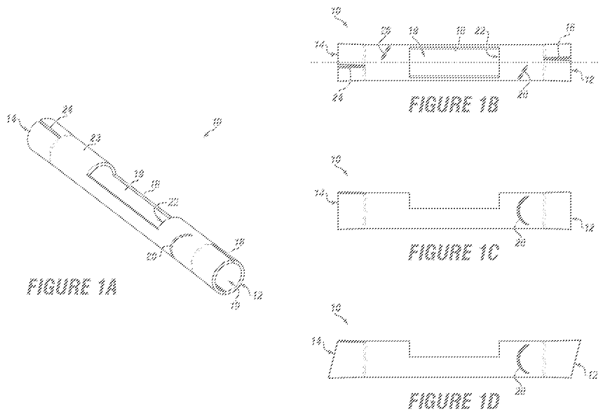

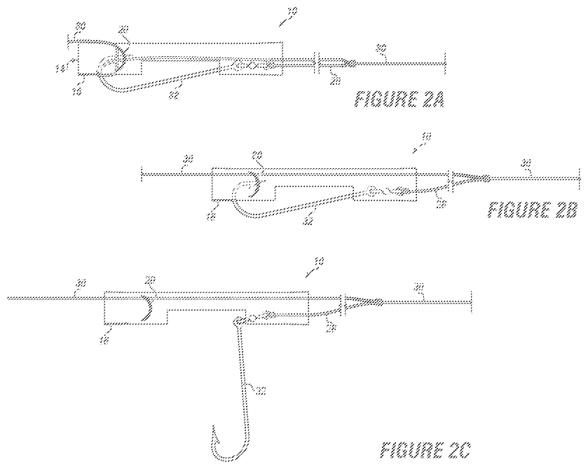

Disclosed are fishing devices, systems and methods that revolve around a hollow tube on fishing line(s) or rope(s), which sometimes is referred to herein as a line. Turning now to the figures, FIG. 1A shows a device comprising a hollow tube 10 having a first end 12 and a second end 14 that are open-ended and located at opposite ends of the hollow tube 10. In some embodiments, such as shown in FIG. 1A, the hollow tube 10 has a first end 12 with at least one slot 16 and a second end 14 with at least one slot 24. In FIG. 1A, the a first end 12 shows the at least one slot 16 as having two slots here 12, but it is understood that there could be one, two, three or more slots at the first end 12 as well as the second end 14 in various embodiments. In addition, the hollow tube 10 may include a first slot 18 located along a longest length of the hollow tube 10. As shown in FIG. 1A, the first slot 18 may be located at least substantially in the middle of the hollow tube 10, wherein its 18 aperture, having any of various shapes, reveals a portion of the hollow tube's 10 interior 19. As such, the first slot 18 produces an aperture that interrupts portions of the body 23 of the hollow tube 10.

FIG. 1A also has the hollow tube 10, serving as a fishing device, including a second slot 20, which may be located between the first end 12 and the first slot 18, wherein the second slot 20 is optionally oriented at least substantially perpendicular to the first slot 18. More particularly and in at least one embodiment, the second slot 20 may be located between the first end 12 and the closest end 22 of the first slot 18 to the first end 12. The shape of the first slot 18 may take any form, but it 18 may be crescent moon shaped, slice into the body 23 at any angle, such as 30°, relative to a top surface of the hollow tube 10, etc.

FIG. 1B shows a top view of the same device as FIG. 1A, but FIG. 1B also includes a third slot 26. The third slot 26 may operate with a second pair of slots 24 approximate to the second end 14, and, more specifically, in embodiments, it 14 is located between the second end 14 and the first slot 18. Such an embodiment may have at least a couple of benefits. For one, a fishing device having at least one slot 16, 24 at each end 12, 14 may let a fisherman correctly slide, attach, snap or otherwise affix the hollow tube 10 to a fishing line without any forethought; that is, the hollow tube is not installed backwards relative to the fishing hook as a skilled artisan would understand at least after discussion of methods herein. For another, a fishing device have at least one slot 16, 24 at each end 12 may result in the hollow tube 10 being able to support two main lines rather than one main line as a skilled artisan would understand at least after discussion of methods herein.

Moving on to FIGS. 1C and 1D, these figures show side views of the hollow tube 10 having a second slot 20, wherein FIG. 1C has straight ends 12, 14 and FIG. 1D has flared ends 12, 14. The particular shape of the first and second ends 12, 14 are optional, and each 12, 14 may have the same shape or different shape.

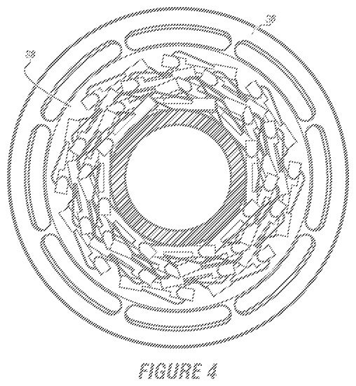

The shape and material of the fishing device may vary in embodiments. In some embodiments, the hollow tube 10 has an ellipsoidal or polygonal cross-section, but other shapes are possible too. In embodiments, the hollow tube 10 may be constructed of various materials, such as metal, wood, plastic or combinations thereof. The hollow tube 10, itself, may be seamless, i.e., an integrated unit such as shown in FIGS. 1A-1D, or, as shown in FIGS. 3A and 3B, may contain a hinge 32 or other connecting fixture that opens and closes, respectively, with a fastening device 33a, 33b, such as a clasp or latching mechanism, to form the hollow tube 10. In still another example embodiment, FIGS. 3C and 3D show portions 35a, 35b removably or irremovably connect, such as by having male and female interlocking members 37a, 37b, whether there is one or multiple sets of such members 37a, 37b, to form the hollow tube 10 with all of some of its 10 limitations as discussed herein. In such an embodiment, the portions 35a, 35b may be extrusion-molded or otherwise manufactured, and assembled to form the hollow tube 10 with all or some of its 10 limitations as discussed herein that constitute the disclosed fishing device either before attaching to the at least one main line 30 or at the time of attaching to the at least one main line 30. As such, interlocking members 37a, 37b located on the inside, outside, or both may unite, such as by snapping, to form the hollow tube 10 with all or some of its 10 limitations as discussed herein.

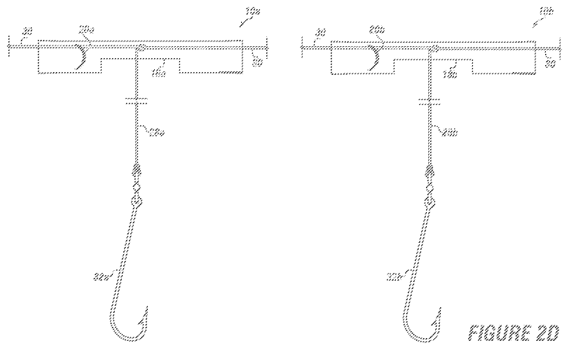

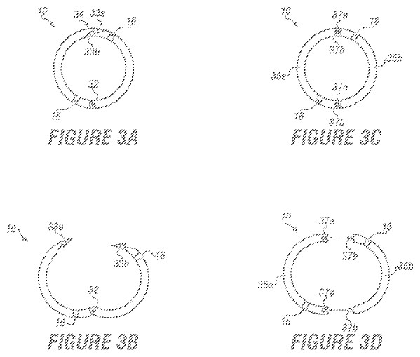

Concentrating now more on example embodiments of methods associated with the disclosed fishing device, focus turns to FIG. 2A. In this figure, depicted is a hollow tube 10 having a fishing hook 32 that may be removably stored in at least one slot in at least one slot 16. To affect this storing, the fishing hook, for instance, may be pulled, pushed or snapped into place within the at least one slot 16. That is, for snapping, the at least one slot 16 may have a restricted channel and/or terminus or otherwise that causes the fishing hook 32 to snap into place at the deepest portion of the at least one slot 16. As depicted, in one embodiment, the fishing hook 32 may be attached to a trot line 28, which is attached to at least one main line 30, which traverses at least a portion of the hollow tube 10. In other, non-depicted embodiments, there may be no trotline 28, and, instead, the fishing hook 32 may be attached directly to at least one main line 30. In FIG. 2A, a portion of the at least one main line 30 may be received in at least one slot 16, the second slot 20 or both. As compared to FIGS. 2A and 2B, the fishing device comprising a hollow tube 10, which may be slid, snapped, hingably mounted, or otherwise attached to the at least one main line 30, has the fishing hook 32 in a stored position. As shown, the fishing hook 32 has its 32 barb safely and removably stored within the interior 19 of the hollow tube 10 so that, for example, a fisherman is not easily stuck by the fishing hook 32, but can still quickly and easily return to fishing without disassembling any lines, e.g., trotline 28 and at least one main line 30.

FIG. 2B shows the same fishing device discussed in FIG. 2A, except that the method evolves as compared to FIG. 2A. In this figure, rather than being received, the fishing hook 32 is readying to be deployed from the at least one slot 16 as the at least one main line 30 has been released from the at least one slot 16, the second slot 20 or both. To affect this deploying, the fishing hook 32, for instance, may be pulled, pushed or unsnapped out of place within the at least one slot 16. That is, for unsnapping, the at least one slot 16 may have a restricted channel and/or terminus or otherwise that causes the fishing hook 32 to snap out of place from the deepest portion of the at least one slot 16. Also noteworthy in discussing the method and FIG. 2B is that the portion of the at least one main line 30 has been released from the at least one slot 16, the second slot 20 or both. As a result, the at least one main line 30 traverses the entire length of the hollow tube 10.

Moving on to FIG. 2C, and as compared to FIGS. 2A and 2B, the fishing hook 32 on a trotline 28 hangs beneath the first slot 18 of the hollow tube 10. Exactly how far the fishing hook 32 hangs beneath first slot 18 may depend on the length of the trotline 28 and size of the fishing hook 32.

FIG. 2D presents an extended aspect of the disclosed fishing devices, methods and systems. That is, FIG. 2D depicts the disclosed fishing devices, methods and systems through use of two fishing devices, i.e., hollow tubes 10a, 10b with some or all of the above-discussed limitations of slots 16, 24, 18, 20, 26, and ends 12, 14 that are attached to their respective trotlines 28a, 28b on at least one main line 30. Extension of this discussion equally applies to more than two fishing devices, wherein two or more fishing devices, staging lines, or otherwise may be referred to herein simply through use of the word, “plurality,” e.g., a plurality of hollow tubes, a plurality of staging lines, etc. Returning to FIG. 2D, depicted are a plurality of fishing devices and lines, that in at least one embodiment includes fishing hooks 32a, 32b attached to trotlines 28a, 28b, which are attached to at least one main line 30, which traverses hollow tubes 10a, 10b. These depicted fishing hooks 32a, 32b are in a deployed state so as to hang beneath their first slots 18a, 18b. Although not depicted, other embodiments may have two or more main lines, wherein some or all of the fishing devices are attached to same or different main lines.

Turning now to FIG. 4 and with the benefit of the foregoing discussion, now it is easy to envision that convenient storage and ready access may be desirable for a plurality of fishing devices having fishing hooks attached to trotlines, which are attached to at least one main line, collectively depicted as 38. In one example, this plurality 38 may be rolled onto or unrolled from a spool 36.

Below are example embodiments of the disclosed inventions:
1. A fishing device comprising:
   a hollow tube having a first end and a second end, wherein the first end and the second end are open-ended and on opposite ends of the hollow tube;
   at least one slot at the first end, wherein the first end is optionally flared;
   a first slot located along a longest length of the hollow tube; and
   a second slot located between the first end and the first slot, wherein the second slot is optionally oriented at least substantially perpendicular to the first slot.
2. The fishing device of claim 1, further comprising at least one slot at the second end.
3. The fishing device of claim 1, further comprising a third slot located between the second end and the first slot, wherein the second end is optionally flared.
4. The fishing device of claim 1, wherein the first slot exposes an interior of the hollow tube.
5. The fishing device of claim 1, wherein the hollow tube has an ellipsoidal or polygonal cross-section.
6. The fishing device of claim 1, wherein the hollow tube comprises metal, wood, plastic, or combinations thereof.
7. The fishing device of claim 1, further comprising a fishing hook removably stored in the at least one slot.
8. The fishing device of claim 1, further comprising a portion of a fishing line or rope within the at least one slot, the second slot, or both.
9. The fishing device of claim 1, further comprising a hinge along the longest length and at least one fastening device on the hollow tube.
10. The fishing device of claim 1, further comprising interlocking members for removably or irremovably uniting portions of the hollow tube.
11. A fishing system comprising:
   a plurality of fishing devices, each of which comprises:
      a hollow tube having a first end and a second end, wherein the first end and the second end are open-ended and on opposite ends of the hollow tube;
      at least one slot at the first end, wherein the first end is optionally flared;
      a first slot located along a longest length of the hollow tube; and
      a second slot located between the first end and the first slot, wherein the second slot is optionally oriented at least substantially perpendicular to the first slot; and
   at least one main line having a plurality of staging lines, wherein at least one of the plurality of staging lines terminates in a fishing hook, wherein the at least one main line traverses the hollow tubes of at least two of the plurality of fishing devices.
12. The fishing system of claim 11, wherein at least one of the hollow tubes is mounted, such as by sliding, snapping, via hinge-and-fastening device, or otherwise onto the at least one main line.
13. The fishing system of claim 11, wherein the fishing hook is stored in or deployed from the at least one slot.
14. The fishing system of claim 11, wherein a portion of the at least one main line is received by or released from the at least one slot, the second slot, or both.
15. A fishing method comprising:
   positioning a fishing device on at least one main line, wherein the fishing device comprises:
      a hollow tube having a first end and a second end, wherein the first end and the second end are open-ended and on opposite ends of the hollow tube;
      at least one slot at the first end, wherein the first end is optionally flared;
      a first slot located along a longest length of the hollow tube; and
      a second slot located between the first end and the first slot, wherein the second slot is optionally oriented at least substantially perpendicular to the first slot; and
   storing or deploying a fishing hook in or from at least one slot of the first pair of slots,
wherein the fishing hook is attached to a staging line attached to the at least one main line.
16. The fishing method of claim 15, wherein the positioning comprises attaching, such as by sliding, snapping, via hinge-and-fastening device, or otherwise attaching the fishing device onto the at least one main line.
17. The fishing method of claim 15, wherein the storing comprises pulling, pushing or snapping.
18. The fishing method of claim 15, wherein the deploying comprises pulling, pushing or unsnapping.
19. The fishing method of claim 15, further comprising receiving or releasing a portion of the main line in or from the at least one slot, the second slot, or both.
20. The fishing method of claim 15, further comprising rolling up or unrolling the at least one main line with the fishing hook located in the at least one slot.

While the foregoing is directed to example embodiments of the disclosed invention, other and further embodiments may be devised without departing from the basic scope thereof, wherein the scope of the disclosed compositions, systems and methods are determined by one or more claims.

What is claimed is:

1. A fishing device comprising:
a hollow tube having a first end and a second end, wherein the first end and the second end are open-ended and on opposite ends of the hollow tube;
at least one slot at the first end, wherein the first end is optionally flared;
a first slot located along a longest length of the hollow tube; and
a second slot located between the first end and the first slot, wherein the second slot is optionally oriented at least substantially perpendicular to the first slot.

2. The fishing device of claim 1, further comprising at least one slot at the second end.

3. The fishing device of claim 1, further comprising a third slot located between the second end and the first slot, wherein the second end is optionally flared.

4. The fishing device of claim 1, wherein the first slot exposes an interior of the hollow tube.

5. The fishing device of claim 1, wherein the hollow tube has an ellipsoidal or polygonal cross-section.

6. The fishing device of claim 1, wherein the hollow tube comprises metal, wood, plastic, or combinations thereof.

7. The fishing device of claim 1, further comprising a fishing hook removably stored in the at least one slot.

8. The fishing device of claim 1, further comprising a portion of a fishing line or rope within the at least one slot, the second slot, or both.

9. The fishing device of claim 1, further comprising a hinge along the longest length and at least one fastening device on the hollow tube.

10. The fishing device of claim 1, further comprising interlocking members for removably or irremovably uniting portions of the hollow tube.

11. A fishing system comprising:
a plurality of fishing devices, each of which comprises:
a hollow tube having a first end and a second end, wherein the first end and the second end are open-ended and on opposite ends of the hollow tube;
at least one slot at the first end, wherein the first end is optionally flared;
a first slot located along a longest length of the hollow tube; and
a second slot located between the first end and the first slot, wherein the second slot is optionally oriented at least substantially perpendicular to the first slot; and
at least one main line having a plurality of staging lines, wherein at least one of the plurality of staging lines terminates in a fishing hook, wherein the at least one main line traverses the hollow tubes of at least two of the plurality of fishing devices.

12. The fishing system of claim 11, wherein at least one of the hollow tubes is mounted onto the at least one main line.

13. The fishing system of claim 11, wherein the fishing hook is stored in or deployed from the at least one slot.

14. The fishing system of claim 11, wherein a portion of the at least one main line is received by or released from the at least one slot, the second slot, or both.

15. A fishing method comprising:
positioning a fishing device on at least one main line, wherein the fishing device comprises:
a hollow tube having a first end and a second end, wherein the first end and the second end are open-ended and on opposite ends of the hollow tube;
at least one slot at the first end, wherein the first end is optionally flared;
a first slot located along a longest length of the hollow tube; and
a second slot located between the first end and the first slot, wherein the second slot is optionally oriented at least substantially perpendicular to the first slot; and
storing or deploying a fishing hook in or from at least one slot of the first pair of slots,
wherein the fishing hook is attached to a staging line attached to the at least one main line.

16. The fishing method of claim 15, wherein the positioning comprises attaching the fishing device onto the at least one main line.

17. The fishing method of claim 15, wherein the storing comprises pulling, pushing or snapping.

18. The fishing method of claim 15, wherein the deploying comprises pulling, pushing or unsnapping.

19. The fishing method of claim 15, further comprising receiving or releasing a portion of the main line in or from the at least one slot, the second slot, or both.

20. The fishing method of claim 15, further comprising rolling up or unrolling the at least one main line with the fishing hook located in the at least one slot.
